(19) United States
(12) Patent Application Publication
(10) Pub. No.: US 2008/0163367 A1
(43) Pub. Date: Jul. 3, 2008

(54) SYSTEM AND METHOD FOR CONTROLLING WEB PAGES ACCESS RIGHTS

(75) Inventors: CHUNG-I LEE, Tu-Cheng (TW); CHIEN-FA YEH, Tu-Cheng (TW); BOR-CHUAN LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/944,423

(22) Filed: Nov. 22, 2007

(30) Foreign Application Priority Data
Dec. 27, 2006 (CN) 200610157777.4

(51) Int. Cl. G06F 21/00

(52) U.S. Cl. 726/21

(57) ABSTRACT

An exemplary method for controlling Web pages access rights is provided. The method includes: inputting an address of a Web page from a user at a client computer for accessing the Web page; popping up a login box for prompting the user to input a web page login at the client computer; receiving the web page login and determining whether the user is permitted to log on the Web page by searching a corresponding user account stored in a database; permitting the user to log on the Web page if the web page login input by the user is matched with the corresponding user account; determining whether the user has a right of accessing the Web page by searching all rights corresponding to the web page login from the database; and reporting a result denoting whether the user is authorized to access the Web page. A related system is also provided.

### BACKGROUND OF THE INVENTION

1. Field of the Invention

The present invention relates to the field of Web page access control or access restriction systems and methods, and more particularly to a system and method for controlling Web page access rights.

2. Description of Related Art

Protection of copyrighted and restriction of accessing Web pages has always been a primary concern to the owners of information. In particular, piracy of information in each of the Web pages has been and continues to be of great concern because it is impossible to stop unauthorized access of the Web pages. Although there have been many prior attempts for restricting access the Web pages, each has been met an inconvenience or a fussy problem. For example, if a user wants to access several Web pages, the attributes of each of the several Web pages must have been modified.

Therefore, what is needed is a system and method for controlling authorities of accessing Web pages, particularly, one which can conveniently restrict users to modify the contents of the Web pages when the users have no authorities of accessing the Web pages.

### SUMMARY OF THE INVENTION

A system for controlling Web pages access rights includes: an application server, a database and at least one client computer, the application server includes an authentication filter, a verifying unit, and an authorization filter. The authentication filter is configured for detecting whether a user has successfully logged on a Web page, and popping up a login box for prompting the user to input a web page login at the at least one client computer. The verifying unit is configured for receiving the web page login from the at least one client computer, and determining whether the web page login is matched with a corresponding user account from the database. The authorization filter includes an authorizing unit that is configured for determining whether the user has a right of accessing the Web page by searching all rights corresponding to the web page login from the database, and reporting a result denoting whether the user is authorized to access the Web page.

A method for controlling Web pages access rights includes: inputting an address of a Web page from a user at a client computer for accessing the Web page; popping up a login box for prompting the user to input a web page login at the client computer; receiving the web page login and determining whether the user is permitted to log on the Web page by searching a corresponding user account stored in a database; permitting the user to log on the Web page if the web page login input by the user is matched with the corresponding user account; determining whether the user has a right of accessing the Web page by searching all rights corresponding to the web page login from the database; and reporting a result denoting whether the user is authorized to access the Web page.

Other novel features of the indicated invention will become more apparent from the following detailed description of the preferred embodiment when taken in conjunction with the accompanying drawings.

### BRIEF DESCRIPTION OF THE DRAWINGS

FIG. 1 is a schematic diagram of a system for controlling Web pages access rights in accordance with one embodiment.

FIG. 2 is a schematic diagram of an inter-structure of an application program in an application server of FIG. 1.

FIG. 3 is a flowchart of a preferred method for controlling Web pages access rights in accordance with another embodiment.

### DETAILED DESCRIPTION OF THE INVENTION

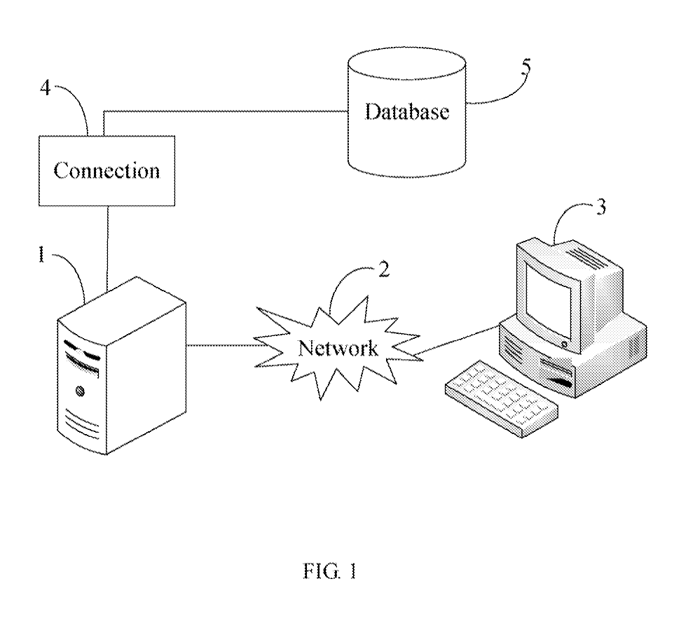

FIG. 1 is a schematic diagram of a system for controlling Web pages access rights (hereinafter, “the system”) in accordance with one embodiment. The system includes an application server 1, at least one client computer 3, and a database 5. The application server 1 is connected with the at least one client computer 3 via a network 2, and connected with the database 5 via a connection 4. The network 2 is a conventional electronic communication network, which can be the intranet, the Internet or any other suitable networks that can transfer data using the transport control protocol and the internet protocol (TCP/IP). The connection 4 is database connectivity, such as open database connectivity (ODBC) or Java database connectivity (JDBC).

The application server 1 includes an application program 10 that is configured for verifying users and granting Web page access rights via the at least one client computer 3. The application server 1 further includes a configuration file, and implements a standard platform (e.g., a Java platform) complying with a standard application model, such as an enterprise edition model (e.g., a J2EE 1.4 model). The configuration file is used for storing configurations of the application program 10, for example, the configuration file stores methods of obtaining data from the database 5.

The database 5 is configured for storing an access control list (ACL) that defines permissions that the users have for accessing the Web pages. The ACL stores user accounts data and Web page access rights. Each of the user accounts includes a user name and a password, and corresponds to at least one Web page. In the preferred embodiment, the user accounts also can be stored in an active directory or a text document configured in the database 5. The Web page access rights of each user name can be stored as a lightweight directory access protocol (LDAP) form. The Web page access rights typically include editing data in the Web pages, uploading data to the Web pages, downloading data from the Web pages, and so on.

LDAP is a protocol for accessing on-line directory services. LDAP defines a relatively simple protocol for updating and searching directories using the TCP/IP. In the preferred embodiment, LDAP adopts a general model. In the general model, the at least one client computer 3 can send an operation request to the application server 1 through the network 2. Following which, the application server 1 performs the operation request from the at least one client computer 3, and transforms a feedback result to the corresponding client computer 3. For example, the feedback result denotes that a user has a right of accessing one Web page. In the preferred embodiment, the operation request typically includes editing data in the Web pages, uploading data to the Web pages, and downloading data from the Web pages.

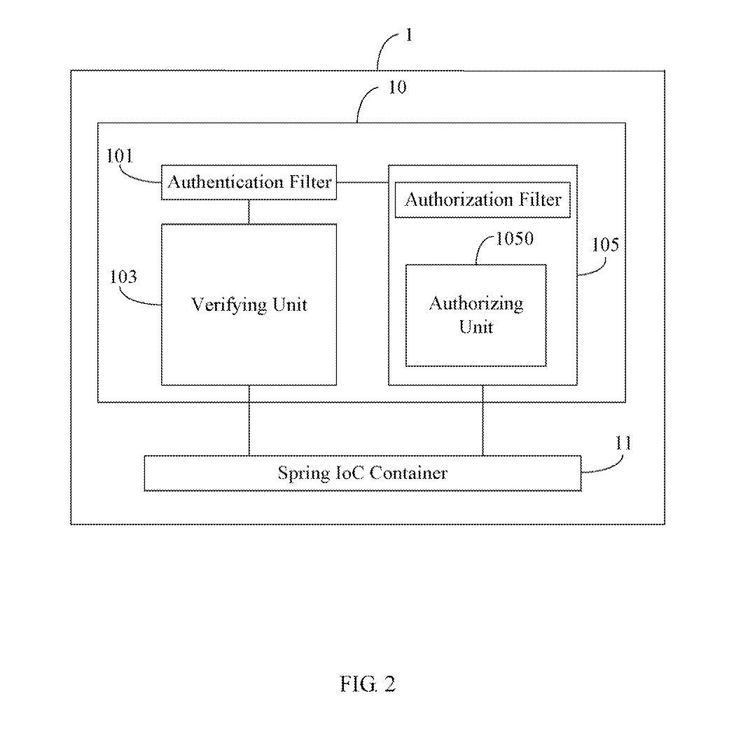

FIG. 2 is a schematic diagram of an inter-structure of the application server 1. The application program 10 electronically connects with a spring framework inversion of control container 11 (describes as “Spring IoC container 11”) that is an execution environment of the application program 10. The application program 10 typically includes an authentication filter 101, a verifying unit 103, and an authorization filter 105. The verifying unit 103 has several types, and each type of the verifying unit 103 corresponds to a java authentication and authorization service (JAAS). The authorization filter 105 includes an authorizing unit 1050.

When a user opens a Web page at the client computer 3, the authentication filter 101 detects whether the user has successfully logged on the Web page. If the user has not successfully logged on the Web page, the verifying unit 103 sends a displaying instruction to the authentication filter 101 for popping up a login box at the client computer 3 for prompting the user to input a web page login. The web page login includes a user name and a password. The verifying unit 103 receives the web page login, and determines whether the user is permitted to log on the Web page by searching a corresponding user account from the database 5. That is, the verifying unit 103 detect whether the user name and the password input by the user matches with a corresponding user account stored in the database 5.

The verifying unit 103 is further configured for sending the displaying instruction to the authentication filter 101 for popping up the login box once more if the user is not permitted to log on the Web page. For example, if the web page login input by the user is an invalid web page login, the authentication filter 101 may prompt the user to reenter the other valid web page login into the login box.

The authorization filter 105 is configured for sending an authorizing instruction to the authorizing unit 1050 for determining whether the user has a right of accessing the Web page if the user is permitted to log on the Web page. That is, the authorizing unit 1050 reads all rights corresponding to the web page login from the database 5, and detects whether the user has the right of accessing the Web page. The authorizing unit 1050 is further configured for reporting a result that denotes whether the user is authorized to access the Web page, and sending the result to the corresponding client computer 3 for displaying to the user.

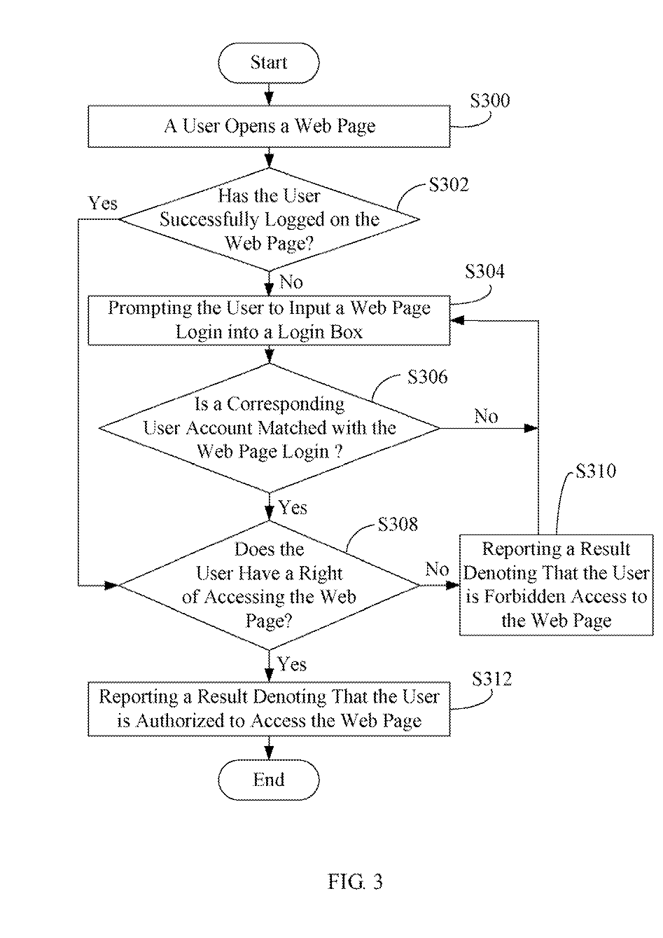

FIG. 3 is a flowchart of a preferred method for controlling authorities of accessing Web pages in accordance with another embodiment. In step S300, a user inputs an address of a Web page into the client computer 3 for opening the Web page. In step S302, the authentication filter 101 detects whether the user has successfully logged on the Web page.

If the user has successfully logged on the Web page, the procedure directly enters into step S308 described below. Otherwise, if the user has not successfully logged on the Web page, in step S304, the verifying unit 103 sends the displaying instruction to the authentication filter 101 for popping up a login box on the client computer 3, and prompts the user to input a web page login including a user name and a password into the login box.

In step S306, the verifying unit 103 receives the web page login, and determines whether the web page login is matched with a corresponding user account stored in the database 5.

If the verifying unit 103 detects no corresponding user account stored in the database 5 is matched with the web page login, the user is not permitted to log on the Web page, the procedure returns to the step S304 described above, and the verifying unit 103 sends the displaying instruction to the authentication filter 101 for popping up the login box once more.

Otherwise, if the web page login is matched with a corresponding user account stored in the database 5, in step S308, the user is permitted to log on the Web page, the authorization filter 105 sends an authorizing instruction to the authorizing unit 1050 to determine whether the user has a right of accessing the Web page by searching all rights corresponding to the web page login from the database 5.

If the user has no right of accessing the Web page, in step S310, the authorizing unit 1050 reports a result denotes that the user is forbidden access to the Web page, and displays the result to the client computer 3 for the user.

If the user has the right of accessing the Web page, in step S312, the authorizing unit 1050 reports a result denotes that the user is authorized to access the Web page, and then allows the user to access the Web page.

In the preferred embodiment, if the user wants to remove the function of controlling authorities of accessing the Web pages, the user can modify related configurations of the configuration file that is configured in the application server 1 without modifying the Web pages.

It is to be understood, however, that even though numerous characteristics and advantages of the indicated invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. A system for controlling Web pages access rights, the system comprising an application server, a database and at least one client computer, the application server comprising:
an authentication filter configured for detecting whether a user has successfully logged on a Web page, and popping up a login box for prompting the user to input a web page login at the at least one client computer;
a verifying unit configured for receiving the web page login from the at least one client computer, and determining whether the web page login is matched with a corresponding user account from the database; and
an authorization filter comprising an authorizing unit configured for determining whether the user has a right of accessing the Web page by searching all rights corresponding to the web page login from the database, and reporting a result denoting whether the user is authorized to access the Web page.

2. The system for controlling Web pages access rights as described in claim 1, wherein the web page login input by the user comprises a user name and a password corresponding to the user name.

3. The system for controlling Web pages access rights as described in claim 1, wherein the application server further comprises a configuration file configured for storing configurations of the application server, and comprises a spring framework inversion of control container that is an execution environment of the configuration file.

4. The system for controlling Web pages access rights as described in claim 1, wherein the database is configured for storing user accounts data that comprising user names and passwords, and storing rights of accessing the Web pages corresponding to each user name.

5. The system for controlling Web pages access rights as described in claim 4, wherein the rights of accessing the Web pages are saved as a lightweight directory access protocol form in the database.

6. A method for controlling Web pages access rights, the method comprising:
inputting an address of a Web page from a user at a client computer for accessing the Web page;
popping up a login box for prompting the user to input a web page login at the client computer;
receiving the web page login and determining whether the user is permitted to log on the Web page by searching a corresponding user account stored in a database;
permitting the user to log on the Web page if the web page login input by the user is matched with the corresponding user account;
determining whether the user has a right of accessing the Web page by searching all rights corresponding to the web page login from the database; and
reporting a result denoting whether the user is authorized to access the Web page.

7. The method for controlling Web pages access rights as described in claim 6, wherein the web page login input by the user comprises a user name and a password corresponding to the user name.

8. The method for controlling Web pages access rights as described in claim 6, wherein the step of reporting a result further comprises:
reporting the result denoting that the user is authorized to access the Web page if the user has the right of accessing the Web page; or
reporting the result denoting that the user is forbidden access to the Web page if the user does not have the right of accessing the Web page.

9. The method for controlling Web pages access rights as described in claim 6, further comprising a step of:
popping up the login box once more for prompting the user to input a valid web page login if the user is not permitted to log on the Web page.

10. The method for controlling Web pages access rights as described in claim 6, wherein the database is configured for storing user accounts data that comprising user names and passwords, and storing rights of accessing the Web pages corresponding to each user name.

11. The method for controlling Web pages access rights as described in claim 10, wherein the rights of accessing the Web pages are saved as a lightweight directory access protocol form in the database.
